(19) United States
(12) Patent Application Publication
(10) Pub. No.: US 2026/0029688 A1
(43) Pub. Date: Jan. 29, 2026

(54) IMAGE SENSING DEVICE

(71) Applicant: Mitsubishi Electric Corporation, Tokyo (JP)

(72) Inventors: Hiroyuki KAWANO, Tokyo (JP); Taisuke MAKITA, Tokyo (JP)

(73) Assignee: Mitsubishi Electric Corporation, Tokyo (JP)

(21) Appl. No.: 18/997,964

(22) PCT Filed: Aug. 1, 2022
(86) PCT No.: PCT/JP2022/029456

§ 371 Date: Jan. 23, 2025

(51) Int. Cl. G03B 15/06; G02B 26/08; G02B 26/10; G02B 27/09; H04N 23/56

(52) U.S. Cl. CPC G03B 15/06; G02B 26/085; G02B 26/101; G02B 27/0955; H04N 23/56

(57) ABSTRACT

An image sensing device includes an illumination device including a light source that emits an optical beam and an illumination optical system that scans a linear illumination region, which linearly extends in a first direction on a virtual reference surface onto which the optical beam is projected, in a second direction orthogonal to the first direction, a camera that executes a photographing operation of scanning a linear image capturing region, which is a region linearly extending in the first direction on the reference surface, in the second direction, and a control circuit that controls the illumination device and the camera so that the linear illumination region and the linear image capturing region keep on overlapping with each other on the reference surface. An optical axis of the illumination device and an optical axis of the camera are non-parallel to each other and intersect with each other on the reference surface.

### TECHNICAL FIELD

The present disclosure relates to an image sensing device.

### BACKGROUND ART

There has been known an image sensing device that is constituted by a projector, a camera and a synchronizing circuit and obtains an image of a target object by means of epipolar imaging (see Patent Reference 1, for example). The projector is an illumination device that scans a beam spot, which is an illumination region formed by a laser beam, in a horizontal direction and a vertical direction. The camera is a rolling shutter camera, for example, and is a photographing device that scans a photographing region in the horizontal direction and the vertical direction. The camera and the projector are arranged to be side by side in an X direction and so that an optical axis of the camera axis and an optical axis of the projector are parallel to each other. The synchronizing circuit controls the operation of the projector and the camera so that an illumination region of the projector and a photographing region of the camera coincide with each other.

By using the epipolar imaging, photographing of an object causing strong reflection scattering (for example, metallic object having luster) can be performed in a state in which reflected scattered light (for example, reflected stray light) is inhibited, and three-dimensional measurement with a reduced error is enabled (see Non-patent Reference 1, for example).

### PRIOR ART REFERENCE

### Patent Reference

Patent Reference 1: U.S. Pat. No. 10,359,277

### Non-Patent Reference

Non-patent Reference 1: Matthew O'Toole et al., “Homogeneous Codes for Energy-Efficient Illumination and Imaging”, ACM SIGGRAPH, 2015

### SUMMARY OF THE INVENTION

### Problem to be Solved by the Invention

However, in the devices described in the aforementioned references, the camera and the projector need to be arranged so that an optical axis of the camera and an optical axis of the projector are parallel to each other in order to perform the epipolar imaging. In this case, there is a problem in that a sensing region as an overlap region between an illuminatable range of the projector and a photographable range of the camera is narrow.

The object of the present disclosure is to provide an image sensing device having a wide sensing region.

### Means for Solving the Problem

An image sensing device in the present disclosure includes an illumination device including a light source that emits an optical beam and an illumination optical system that scans a linear illumination region, which linearly extends in a first direction on a virtual reference surface as an illumination region onto which the optical beam is projected, in a second direction as a direction orthogonal to the first direction; a camera that executes a photographing operation of scanning a linear image capturing region, which is an image capturing region linearly extending in the first direction on the reference surface, in the second direction; and a control circuit that controls operation of the illumination device and the photographing operation of the camera so that the linear illumination region and the linear image capturing region keep on overlapping with each other on the reference surface. An optical axis of the illumination device and an optical axis of the camera are non-parallel to each other and intersect with each other on the reference surface.

### Effect of the Invention

According to the present disclosure, the sensing region can be widened.

### BRIEF DESCRIPTION OF THE DRAWINGS

FIG. 1 is a perspective view schematically showing a main configuration of an image sensing device according to a first embodiment.

FIG. 2 is a plan view schematically showing the main configuration of the image sensing device in FIG. 1.

FIG. 3 is a perspective view schematically showing a main configuration of a laser scanner in FIG. 1.

FIG. 4 is a plan view schematically showing the main configuration of the laser scanner in FIG. 1.

FIG. 5 is a side view schematically showing the main configuration of the laser scanner in FIG. 1.

FIG. 6(A) is a diagram showing the operation of an image sensing device in a comparative example (in a case where the device does not include a trapezoidal distortion generation element), and FIGS. 6(B) to 6(E) are diagrams showing the operation of the image sensing device in FIG. 1.

FIG. 7 is a plan view showing the operation of a camera in FIG. 1.

FIG. 8 is a plan view showing the operation of the laser scanner in FIG. 1.

FIG. 9 is a plan view showing the operation of the camera and the laser scanner in FIG. 1.

FIG. 10 is a plan view schematically showing a main configuration of an image sensing device according to a modification of the first embodiment.

FIG. 11 is a perspective view schematically showing a main configuration of an image sensing device in a comparative example (in a case where an optical axis of the camera and an optical axis of the laser scanner are parallel to each other).

FIG. 12 is a plan view schematically showing the main configuration of the image sensing device in FIG. 11.

FIGS. 13(A) to 13(C) are diagrams showing the operation of the image sensing device in FIG. 11.

FIG. 14 is a plan view schematically showing a main configuration of an image sensing device in a comparative example (in a case where the optical axis of the laser scanner is inclined with respect to the optical axis of the camera).

FIGS. 15(A) to 15(C) are diagrams showing the operation of the image sensing device in FIG. 14 (in the case where the optical axis of the laser scanner is inclined).

FIG. 16 is a perspective view schematically showing a main configuration of a laser scanner of an image sensing device according to a second embodiment.

FIG. 17 is a plan view schematically showing the main configuration of the laser scanner in FIG. 16.

FIG. 18 is a side view schematically showing the main configuration of the laser scanner in FIG. 16.

FIG. 19 is a plan view schematically showing a main configuration of the image sensing device according to the second embodiment.

FIGS. 20(A) and 20(B) are diagrams showing the operation of the image sensing device according to the second embodiment.

FIGS. 21(A) and 21(B) are diagrams showing angle functions of galvanometer mirrors of the image sensing device according to the second embodiment.

FIGS. 22(A) to 22(C) are diagrams showing the angle functions of the galvanometer mirrors for correcting distortion on an illumination reference surface in the image sensing device according to the second embodiment.

FIGS. 23(A) to 23(C) are diagrams showing the angle functions of the galvanometer mirrors for correcting distortion on an image capturing reference surface in the image sensing device according to the second embodiment.

FIG. 24 is a perspective view schematically showing a main configuration of a laser scanner of an image sensing device according to a third embodiment.

FIG. 25 is a plan view schematically showing the main configuration of the laser scanner in FIG. 24.

FIG. 26 is a side view schematically showing the main configuration of the laser scanner in FIG. 24.

FIG. 27 is a diagram for explaining the distortion on the illumination reference surface in an image sensing device in a comparative example (in a case where the device does not include a trapezoidal distortion generation lens).

FIG. 28 is a diagram for explaining the distortion on the image capturing reference surface in the image sensing device in the comparative example (in the case where the device does not include the trapezoidal distortion generation lens).

FIG. 29 is a diagram showing the locus of the beam on the illumination reference surface in the image sensing device according to the third embodiment.

FIG. 30 is a diagram showing the locus of the beam on the image capturing reference surface in the image sensing device according to the third embodiment.

FIG. 31 is a perspective view schematically showing a main configuration of a laser scanner including a free-form surface lens in the image sensing device according to the third embodiment.

FIG. 32 is a side view schematically showing the main configuration of the laser scanner in FIG. 31.

FIG. 33 is a plan view schematically showing the main configuration of the laser scanner in FIG. 31.

FIG. 34 is a diagram showing cross-sectional profiles of a first surface and a second surface of the free-form surface lens of the image sensing device according to the third embodiment.

FIG. 35 is a diagram showing cross-sectional profiles of the first surface and the second surface of the free-form surface lens of the image sensing device according to the third embodiment.

FIG. 36 is a diagram showing the locus of the laser beam on the image capturing reference surface obtained by controlling a low-speed shaft of a two-dimensional MEMS mirror of the image sensing device according to the third embodiment.

FIG. 37 is a diagram showing a stripe pattern formed when the laser beam is turned on and off at even time intervals.

FIG. 38 is a diagram showing a vertical stripe pattern formed by controlling on and off times of the laser beam.

FIG. 39 is a plan view schematically showing a main configuration of an image sensing device according to a fourth embodiment.

### MODE FOR CARRYING OUT THE INVENTION

Image sensing devices according to embodiments will be described below with reference to the drawings. The following embodiments are just examples and it is possible to appropriately combine embodiments and appropriately modify each embodiment. In the drawings, components having the same or similar function are assigned the same reference numerals.

### (1) First Embodiment

### (1-1) Configuration

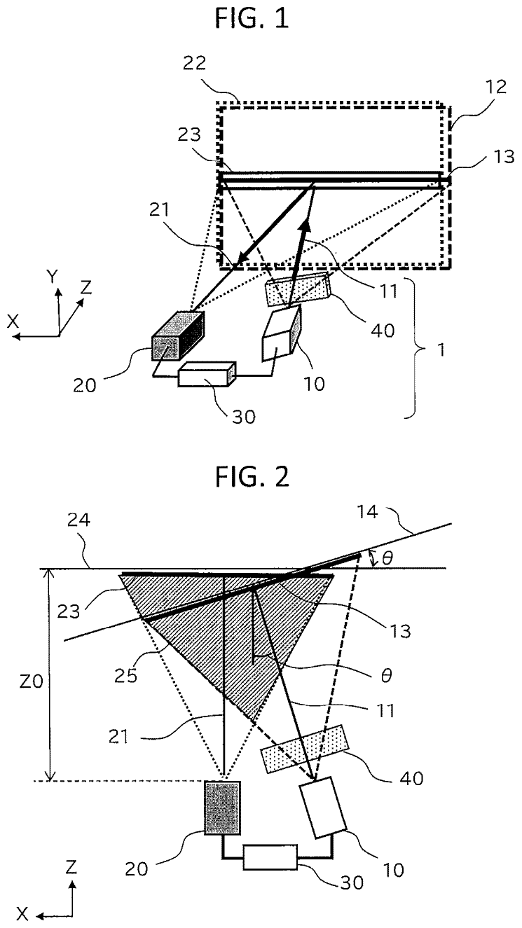

FIG. 1 and FIG. 2 are a perspective view and a plan view schematically showing a main configuration of an image sensing device 1 according to a first embodiment. The image sensing device 1 is a device that performs the epipolar imaging. The image sensing device 1 includes a camera 20 as an image capturing device, a laser scanner 10 as an illumination device, a control circuit 30 including a synchronizing circuit, and a trapezoidal distortion generation element 40. The camera 20 and the laser scanner 10 are arranged side by side in an X direction, and an optical axis 21 of the camera 20 and an optical axis 11 of the laser scanner 10 are non-parallel to each other and intersect with each other at a position in front of the camera 20 and the laser scanner 10. In the first embodiment, the trapezoidal distortion generation element 40 is inserted in front of the laser scanner 10.

An image capturing reference surface 24 (referred to also as an “image capturing screen”), which is a planar virtual screen orthogonal to the optical axis 21 of the camera 20, is set at a position separate from the camera 20 by a certain distance Z0. Further, an illumination reference surface 14 (referred to also as an “illumination screen”), which is a planar virtual screen orthogonal to the optical axis of the laser scanner 10 and is a laser projection reference surface inclined by an angle θ with respect to the image capturing reference surface 24, is set. The image capturing reference surface 24 and the illumination reference surface 14 are not physical entities but represent virtual planes for explanation. Incidentally, the optical axis 21 of the camera 20 and the optical axis 11 of the laser scanner 10 intersect with each other on the illumination reference surface 14 as a virtual reference surface.

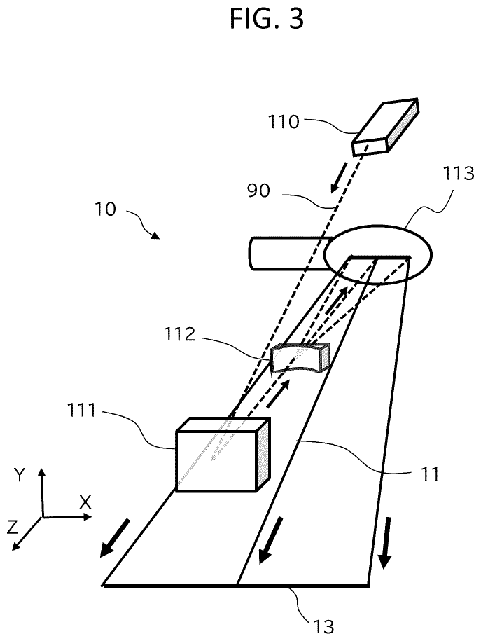

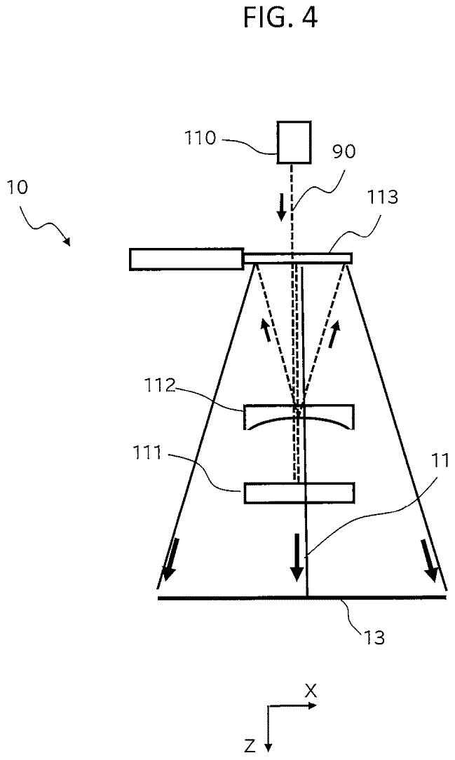

FIG. 3 to FIG. 5 are a perspective view, a plan view and a side view schematically showing the configuration of the laser scanner 10 in FIG. 1. A laser beam (referred to also as an “expanding beam”) broadening in a fan shape in the X direction as a first direction is emitted from the laser scanner 10. On the illumination reference surface 14, the laser beam forms a linear illumination region 13 which is an expanded laser beam extending in the X direction (i.e., linear beam having a linear cross section).

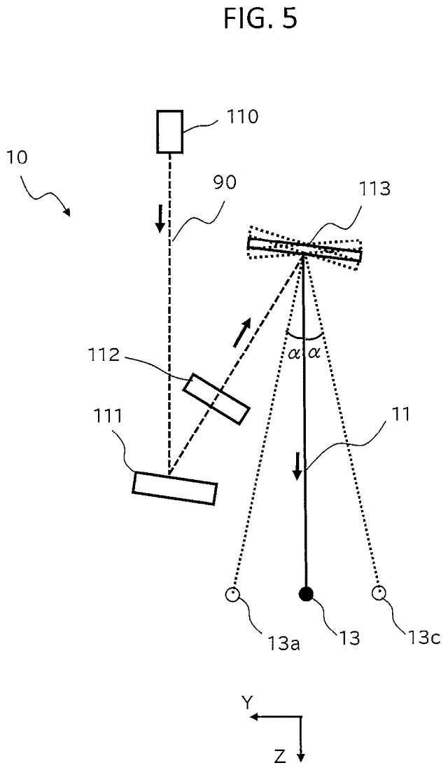

The laser scanner 10 includes a laser light source 110 as a light source that emits a laser beam as an optical beam and an illumination optical system that scans the linear illumination region 13 in a Y direction as a second direction orthogonal to the X direction. The linear illumination region 13 linearly extends in the X direction on the illumination reference surface 14 as an illumination region onto which the laser beam is projected and a virtual reference surface. The laser beam is emitted from the laser light source 110, reflected by a mirror 111, and thereafter forms the linear illumination region 13 as a linear beam extending in the X direction by means of a beam expanding optical element 112 being a lens. The beam expanding optical element 112 is an optical lens such as a cylindrical lens or a Powell lens, for example. As shown in FIG. 5, the linear illumination region 13 is deflected in a Z direction by a galvanometer mirror 113 as a scanning optical unit. The galvanometer mirror 113 is capable of swinging around an X-axis within a predetermined angular range ±(α/2), by which the linear illumination region 13 is scanned around the X-axis within an angular range ±α that is twice the predetermined angular range (namely, scanned within a range between a linear illumination region 13a and a linear illumination region 13c in FIG. 5). On the image capturing reference surface 24, the linear illumination region 13 is scanned in the Y direction, and thus a region of an entire laser scan range 12 in FIG. 1 is irradiated.

The camera 20 executes a photographing operation of scanning a linear image capturing region 23 in the Y direction. The linear image capturing region 23 is an image capturing region linearly extending in the X direction on the image capturing reference surface 24. The control circuit 30 controls the operation of the laser scanner 10 and the photographing operation of the camera 20 so that the linear illumination region 13 and the linear image capturing region 23 keep on overlapping with each other on the image capturing reference surface 24. The control circuit 30 may be constituted by a memory storing a software program and a processor. In this case, the function of the control circuit 30 is implemented by the processor executing the software program stored in the memory.

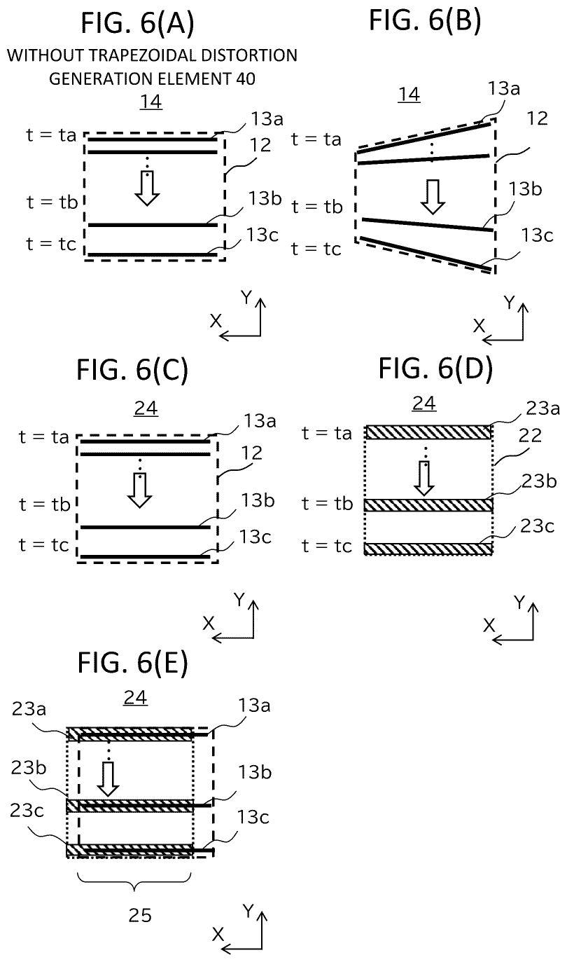

FIG. 6(A) is a diagram showing the operation of an image sensing device in a comparative example (in a case where the device does not include the trapezoidal distortion generation element). FIG. 6(A) shows the linear illumination region 13 on the illumination reference surface 14 of the image sensing device in the comparative example.

FIGS. 6(B) to 6(E) are diagrams showing the operation of the image sensing device 1 in the first embodiment. FIG. 6(B) shows the linear illumination region 13 on the illumination reference surface 14, FIG. 6(C) shows the linear illumination region 13 on the image capturing reference surface 24 in the first embodiment, FIG. 6(D) shows the linear image capturing region 23 on the image capturing reference surface 24, and FIG. 6(E) shows the linear illumination region 13 and the linear image capturing region 23 on the image capturing reference surface 24.

As shown in FIG. 6(A), in the image sensing device in the comparative example without the trapezoidal distortion generation element 40, on the illumination reference surface 14, the scanning of the linear illumination region 13 in the −Y direction at a speed VL in the entire laser scan range 12 from its upper end to its lower end is repeated. At a time t=ta, the linear illumination region 13 exists as a linear illumination region 13a at the upper end of the entire laser scan range 12. At a time t=tb, the linear illumination region 13 is indicated as a linear illumination region 13b. At a time t=tc, the linear illumination region 13 exists as a linear illumination region 13c at the lower end of the entire laser scan range 12. After reaching the lower end, the linear illumination region 13 returns to the upper end at high speed and repeats the above-described operation.

In the first embodiment, due to the existence of the trapezoidal distortion generation element 40, the entire laser scan range 12 on the illumination reference surface 14 has a trapezoidal shape as shown in FIG. 6(B). Specifically, the linear illumination region 13a at the time t=ta is a straight line ascending to the right. Rotation of the linear illumination region 13 in an XY plane progresses with the progress of the scan in the −Y direction, and the linear illumination region 13c at the lower end is a straight line descending to the right. The image capturing reference surface 24 orthogonal to the optical axis 21 is inclined (inclined so as to approach the X direction) with respect to a plane orthogonal to the optical axis 11. The trapezoidal distortion generation element 40 has a function of making an extending direction of the linear illumination region 13 approach an extending direction of the linear image capturing region 23 on the illumination reference surface 14. On the image capturing reference surface 24, the linear illumination region 13 being parallel to the X direction is scanned from t=ta to t=tc as shown in FIG. 6(C). While the trapezoidal distortion generation element 40 is designed to implement the movement shown in FIG. 6(C), concrete design of the trapezoidal distortion generation element 40 will be described later.

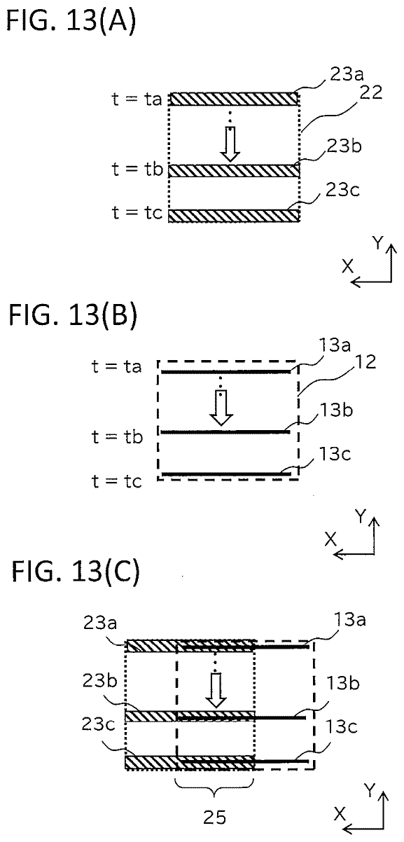

The camera 20 is a rolling shutter camera, and is capable of repeating the operation of scanning the linear image capturing region extending in the X direction in the −Y direction by shortening an exposure time. The scan of the image capturing region of the camera 20 has been described in FIG. 13 and its explanation in the Non-patent Reference 1, for example. On the image capturing reference surface 24, the image capturing range 12 of the camera 20 is scanned from the upper end to the lower end of an entire image capturing range 22 of the camera 20. The manner of the scanning is shown in FIG. 6(D). The linear image capturing region 23 of the camera 20 is scanned at a speed Vc from a linear image capturing region 23a at the upper end of the entire image capturing range 22 to a linear image capturing region 23c at the lower end of the entire image capturing range 22. In this case, the device configuration is previously set so that the linear image capturing region 23a of the camera 20 and the linear illumination region 13a overlap with each other in the Y direction on the image capturing reference surface 24. The setting can be made by setting the zooming of the lens of the camera 20, the ROI (Region Of Interest) restricting an image capturing area of the camera 20, a scan range of the linear illumination region 13 in the Y direction, and the like. A mechanism for finely adjusting installation postures of the camera 20 and the laser scanner 10 is also important.

By the control circuit 30, an image capturing time of the linear image capturing region 23a and an irradiation time of the linear illumination region 13a are made to coincide with each other at t=ta. Further, the scan speed Vc of the linear image capturing region 23 in the −Y direction and the scan speed VL of the linear illumination region 13 in the −Y direction are made to coincide with each other. Then, as shown in FIG. 6(E), the linear image capturing region 23 and the linear illumination region 13 are scanned from the top to the bottom during one cycle from the time t=ta to the time t=tc with their positions in the Y direction constantly overlapping with each other (preferably, while constantly overlapping with each other). The linear image capturing region 23 and the linear illumination region 13 are moved by repeating this cycle. A superimposition range of the entire image capturing range 22 and the entire laser scan range 12 of the linear illumination region 13 is a range where the epipolar imaging is possible.

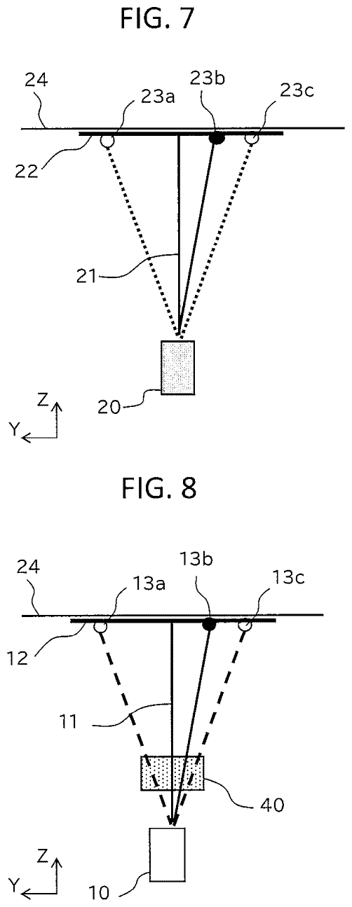

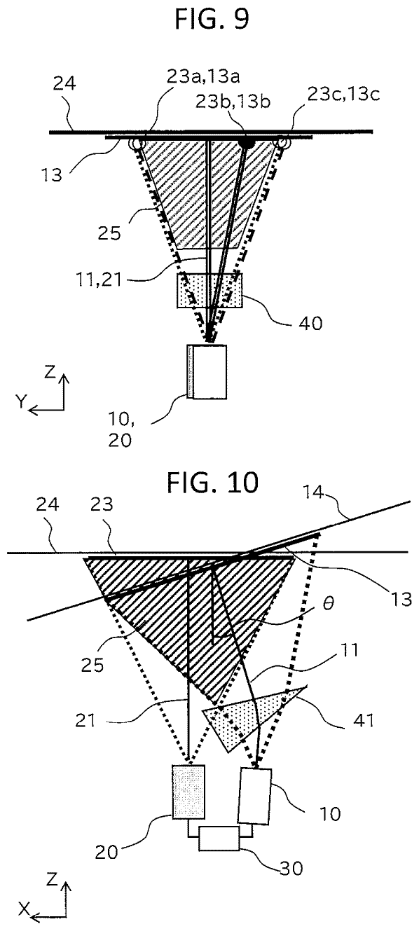

Here, it is important that the camera 20 and the laser scanner 10 are arranged side by side in the X direction, namely, the camera 20 and the laser scanner 10 are at the same position coordinates in the Y direction and the Z direction (condition A). By this arrangement, the linear illumination region 13 and the linear image capturing region 23 are arranged to keep on overlapping with each other as shown in FIG. 6(E) irrespective of the distance Z from the camera 20 to the image capturing reference surface 24 in front of the camera 20. The reason for this will be described below by using FIG. 7 to FIG. 9. FIG. 7 to FIG. 9 are diagrams for explaining the movement of the linear image capturing region of the image sensing device 1 according to the first embodiment and a line laser beam as a beam forming the linear illumination region 13 in cross-sectional directions (in a YZ plane). Specifically, FIG. 7 is a plan view showing the operation of the camera in FIG. 1, FIG. 8 is a plan view showing the operation of the laser scanner in FIG. 1, and FIG. 9 is a plan view showing the operation of the camera and the laser scanner in FIG. 1.

FIG. 7 is a diagram showing the range of the scanning of the linear image capturing region 23 by the camera 20 projected on the YZ plane. FIG. 8 is a diagram showing the range of the scanning of the linear illumination region 13 from the laser scanner 10 projected on the YZ plane. Exclusively when the aforementioned condition A is satisfied, the scan ranges in FIG. 7 and FIG. 8 coincide with each other, and in addition, loci of the linear image capturing region 23b and the linear illumination region 13b on the YZ plane at an arbitrary time t=tb coincide with each other. The manner of the coincidence is shown in FIG. 9. Therefore, a sensing region 25 is formed as a wide region like the hatched region shown in FIG. 9 and the epipolar imaging is made possible at any position in the Z direction. However, as is clear from FIG. 2, in a range where Z is small (a range extremely close to the camera), the image capturing range of the camera 20 and the scan range of the linear illumination region 13 do not overlap with each other on an XZ plane and thus the epipolar imaging cannot be performed. Incidentally, while a far region of the sensing region 25 is demarcated by the image capturing reference surface 24 in FIG. 2 and FIG. 9, the sensing region 25 in reality extends farther than the image capturing reference surface 24. The real far limit of the sensing region 25 is determined by the amount of detectable signals since the amount of light received by the camera 20 decreases with the increase in the distance.

Specifically, the function of the trapezoidal distortion generation element 40 can be achieved by using a wedge-shaped prism. Patent Reference 2 shows an example in which the trapezoidal distortion of a projected pattern on a screen in the vertical direction is corrected by inserting a wedge-shaped prism at a light emission surface of a projector projecting an image obliquely upward.

Patent Reference 2: Japanese Patent Application Publication No. 2016-105179

FIG. 10 is a diagram showing a configuration example of the image sensing device according to the first embodiment. The trapezoidal distortion in the horizontal direction is generated by inserting a wedge-shaped prism in front of the laser scanner 10. In FIG. 10, the apex of the wedge-shaped prism 41 is situated on the right side and the optical axis 11 passing through the wedge-shaped prism 41 is deflected leftward. Here, the illumination reference surface 14 is orthogonal to the optical axis 11 after exiting from the wedge-shaped prism 41. Further, an angle formed by the optical axis 11 and a normal line to the image capturing reference surface 24 is defined as θ. It is desirable to design the shape, the material and an installation angle of the wedge-shaped prism 41 and an installation angle of the laser scanner 10 so that the trapezoidal distortion in the horizontal direction on the image capturing reference surface 24 is eliminated and all of the linear illumination regions 13a to 13C on the image capturing reference surface 24 are made parallel to the X-axis as shown in FIG. 9.

### (1-3) Comparative Example

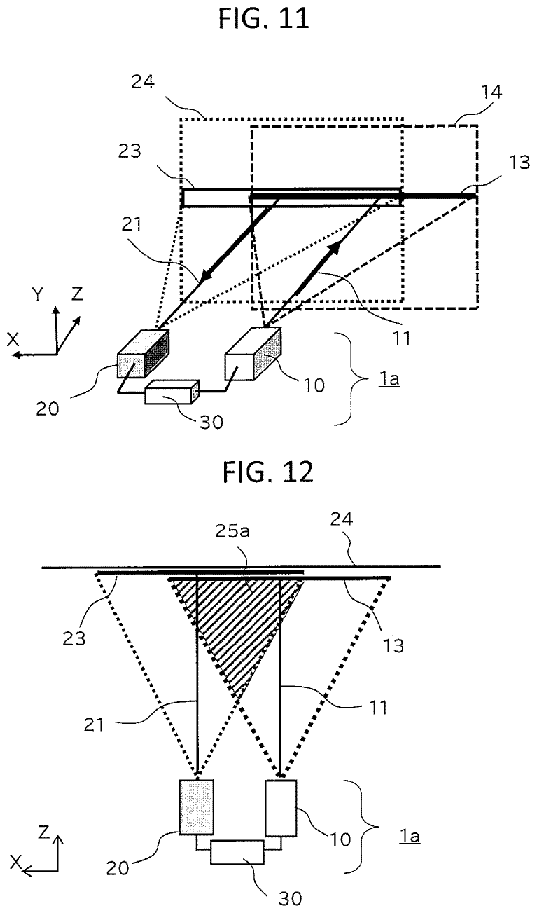

FIG. 11 and FIG. 12 are a perspective view and a plan view schematically showing a main configuration of an image sensing device 1a in a comparative example that performs the epipolar imaging. The image sensing device 1a in the comparative example is constituted by of the camera 20, the laser scanner 10 and the control circuit 30. The camera 20 and the laser scanner 10 are arranged side by side in the X direction, and the optical axis 21 of the camera 20 and the optical axis 11 of the laser scanner 10 are parallel to each other and directed in the Z direction. It is assumed that the image capturing reference surface 24 as a virtual screen orthogonal to the optical axis 21 of the camera 20 is situated at a position separate from the camera 20 by a certain distance Z0.

FIGS. 13(A) to 13(C) are diagrams for explaining the operation of the image sensing device 1a in the comparative example performing the epipolar imaging. FIG. 13(A) shows the manner of the scanning of the linear image capturing region 23 on the image capturing reference surface 24 by the rolling shutter camera. This movement is the same as the movement described earlier with reference to FIG. 6(D).

FIG. 13(B) shows the movement of the linear illumination region 13 and FIG. 13(C) shows the state in which the linear image capturing region 23 and the linear illumination region 13 are overlapped with each other.

FIG. 13(B) shows the manner of the scanning of the linear illumination region 13 on the image capturing reference surface 24 by the laser scanner 10. In the configuration in the comparative example shown in FIG. 11 and FIG. 12, the image capturing reference surface 24 is orthogonal to the laser scanner 10, and thus the linear illumination region 13 is scanned from the linear illumination region 13a to the linear illumination region 13c parallel to the X direction similarly to the case described earlier with reference to FIG. 6(A).

Similarly to the description above, synchronization of the camera 20 and the laser scanner 10 is established by using the control circuit 30 and the image sensing device is operated so that the positions of the linear image capturing region 23 and the linear illumination region 13 in the Y direction on the image capturing reference surface 24 keep on overlapping with each other (preferably, constantly overlap with each other). FIG. 13(C) shows the manner of the overlap of the linear illumination region 13 and the linear image capturing region 23 on the image capturing reference surface 24. An overlap region of the two regions 13 and 23 on the image capturing reference surface 24 is smaller than that described above with reference to FIG. 6(E). In FIG. 12, the sensing region 25 as the overlap region is indicated by hatching. When the sensing region 25 in FIG. 2 and the sensing region 25 in FIG. 12 are compared with each other, it is clear that the image sensing device 101 in the comparative example has a problem in that the sensing region 25 where the epipolar imaging is possible is small. In order to enlarge the sensing region 25, it is sufficient to reduce the spacing between the camera 20 and the laser scanner 10 while maintaining the parallelism of the optical axis 21 and the optical axis 11, but there is a limitation due to sizes of devices. Further, as will be described later as explanation of a second embodiment and a configuration example 2 in a third embodiment, one major application of the epipolar imaging is 3D sensing by means of stripe pattern projection. Since the stripe pattern projection method employs the principle of triangulation, it is desirable to widen the spacing between the laser scanner 10 and the camera 20 in the X direction in order to raise the measurement accuracy in a depth direction. However, the optical axis 21 and the optical axis 11 remain parallel to each other in the conventional epipolar imaging, and thus there is a problem in that the sensing region 25, which is the region where 3D sensing is possible, is small.

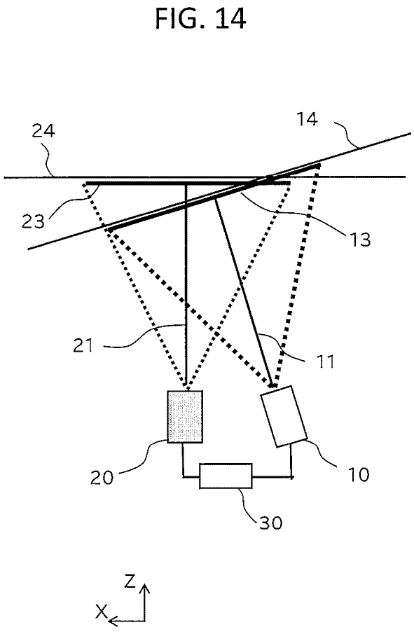

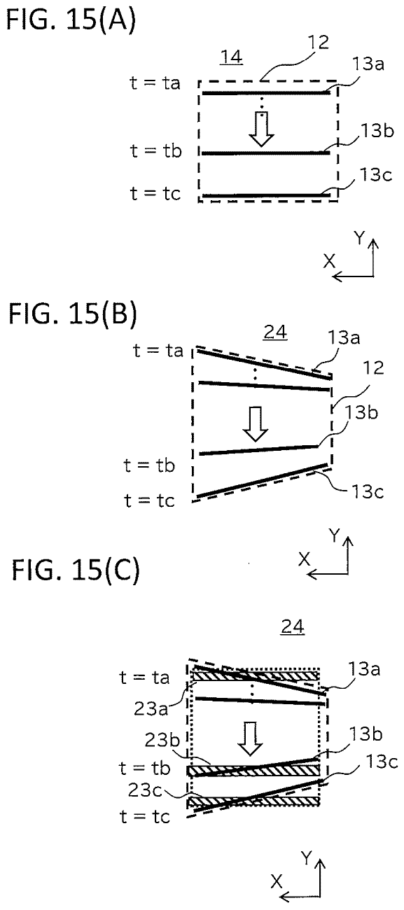

FIG. 14 and FIGS. 15(A) to 15(C) are diagrams for explaining the operation in a case where the optical axis of the laser scanner 10 is inclined in the image sensing device in the comparative example performing the epipolar imaging. FIG. 14 is a main configuration diagram, FIG. 15(A) shows the movement of the linear illumination region 13 on the illumination reference surface 14, FIG. 15(B) shows the movement of the linear illumination region 13 on the image capturing reference surface 24, and FIG. 15(C) shows the movement of the linear image capturing region 23 and the linear illumination region 13 overlapped with each other on the image capturing reference surface 24.

If the optical axis 11 of the laser scanner 10 is inclined in the X direction as shown in FIG. 1 in order to widen the width of the sensing region 25 in the X direction, the optical axis 21 and the optical axis 11 are made non-parallel to each other. Then, since the image capturing reference surface 24 orthogonal to the optical axis 21 of the camera 20 is inclined with respect to the optical axis 11, the linear illumination region 13 on the image capturing reference surface 24 is such that the linear illumination region 13a at the upper end is a straight line descending to the right as shown in FIG. 15(B), the rotation in the XY plane progresses with the progress of the scan, and the linear illumination region 13c at the lower end is a straight line ascending to the right. On the other hand, the linear image capturing region on the image capturing reference surface 24 is scanned from the top to the bottom while maintaining the parallelism as shown in FIG. 13(A). FIG. 15(C) shows the manner of the overlap of the linear image capturing region 23 and the linear illumination region 13 on the image capturing reference surface 24 when the control circuit 30 controls the positions of the linear image capturing region 23 and the linear illumination region 13 in the Y direction to coincide with each other on the image capturing reference surface 24. As is clear from FIG. 15(C), it is impossible to scan the linear image capturing region 23 and the linear illumination region 13 while overlapping them with each other, since the inclination of the linear illumination region 13 rotates on the image capturing reference surface 24. Although the linear image capturing region 23 and the linear illumination region 13 are parallel to each other only for a moment at an intermediate position in the Y direction, the sensing region in the Y direction is extremely narrow and it is difficult to use the image sensing device as the sensor for the epipolar imaging.

### (1-4) Effect

In the image sensing device 1 according to the first embodiment, the trapezoidal distortion generation element 40 designed appropriately is inserted in front of the laser scanner 10, which makes it possible to scan the line laser beam parallel to the X direction in the Y direction on the image capturing reference surface 24 inclined with respect to the optical axis 21. Accordingly, advantages are obtained in that the epipolar imaging can be performed even if the optical axis 11 is inclined with respect to the optical axis 21 and thus the sensing region 25 can be enlarged.

Incidentally, while the above description has been given of examples in which the galvanometer mirror 113 is used as a beam scan device, the same advantages can be obtained even by using a one-dimensional MEMS (Micro Electro Mechanical Systems) mirror having the function of rotationally oscillating a mirror at high speed. It is also possible to employ a scanner that rotates a polygon mirror as a polyhedral mirror with a motor instead of the galvanometer mirror 113.

### (2) Second Embodiment

### (2-1) Configuration

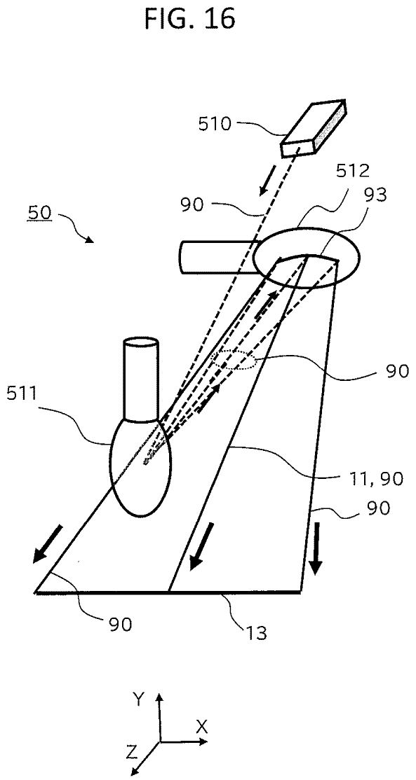

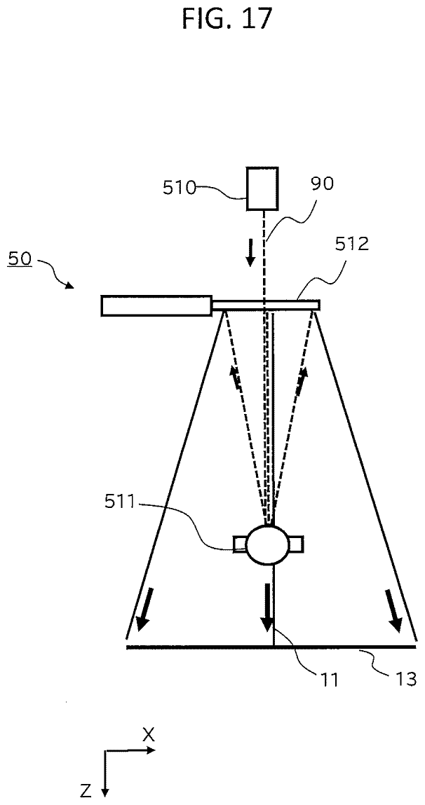

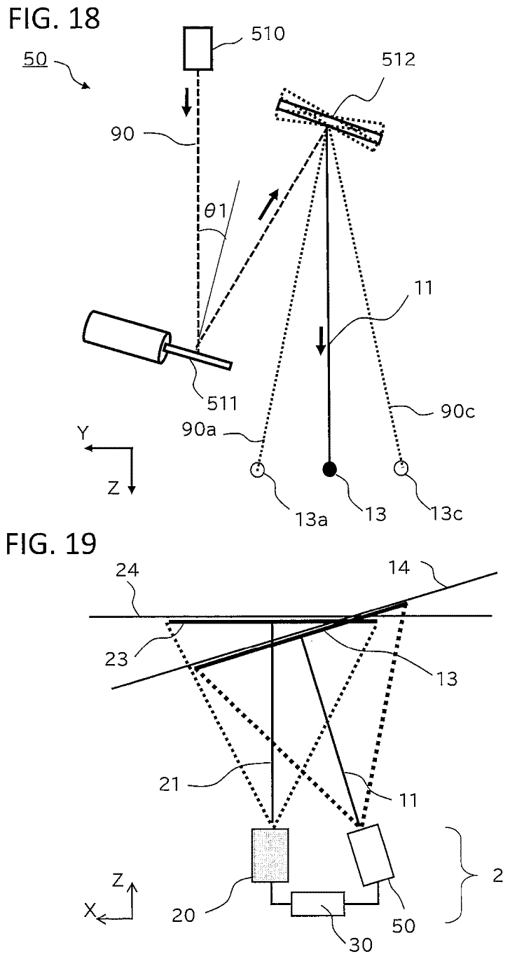

FIG. 16 is a perspective view schematically showing a main configuration of a laser scanner 50 as the illumination device of an image sensing device 2 according to a second embodiment. FIG. 17 and FIG. 18 are a plan view and a side view schematically showing the main configuration of the laser scanner 50 in FIG. 16. FIG. 19 is a plan view schematically showing a main configuration of the image sensing device 2 according to the second embodiment. Here, the XYZ coordinate axes in FIG. 16 to FIG. 18 represent local coordinates of the laser scanner 50, and a Z-axis in FIG. 16 to FIG. 18 extends in the direction of the optical axis 11. Namely, the Z direction in FIG. 19 and the Z direction in FIG. 16 to FIG. 18 differ from each other. The second embodiment differs from the first embodiment in that the laser scanner 50 is constituted by two galvanometer mirrors 511 and 512. A laser beam 90 emitted from a laser light source 510 travels in the Z-axis direction and is reflected by the galvanometer mirror 511 as a first scanning optical unit. The galvanometer mirror 511 is capable of changing a rotation angle θy of a mirror around a rotation axis at high speed within a range of ±10 degrees. As shown in FIG. 18, the rotation axis is inclined with respect to the Y-axis by an angle θ1.

The laser beam 90 reflected by the galvanometer mirror 511 reaches the galvanometer mirror 512 as a second scanning optical unit. Since the galvanometer mirror 511 is reciprocating at high speed, the laser beam 90 reaching the galvanometer mirror 512 draws a curved locus being convex upward as indicated by the reference character 93 in FIG. 16. The locus is formed not as a straight line but as a curved line because the light incident upon the galvanometer mirror 511 obliquely from above in the Y direction is scanned in the X direction. The galvanometer mirror 512 is capable of changing a rotation angle θx of a mirror around a rotation axis within a range of ±6 degrees, and the rotation axis is directed in the X-axis direction. The posture of the galvanometer mirror 512 when θx=0 has been determined so that an emission direction of the laser beam 90, namely, the optical axis 11 when θy=0 and θx=0 is directed in the Z-axis. The laser beam 90 reflected by the galvanometer mirror 512 is the laser beam 90a in FIG. 18 when the galvanometer mirror 512 is at −6 degrees and is the laser beam 90c in FIG. 18 when the galvanometer mirror 512 is at +6 degrees.

### (2-2) Operation

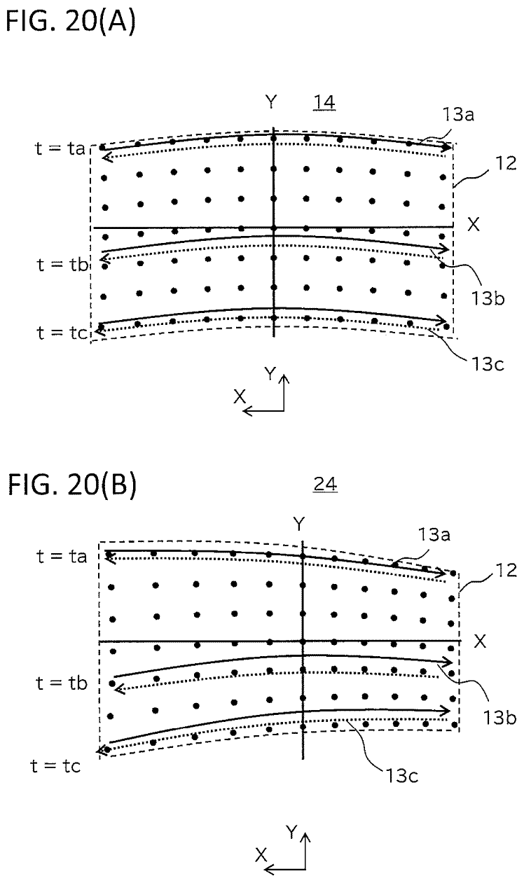

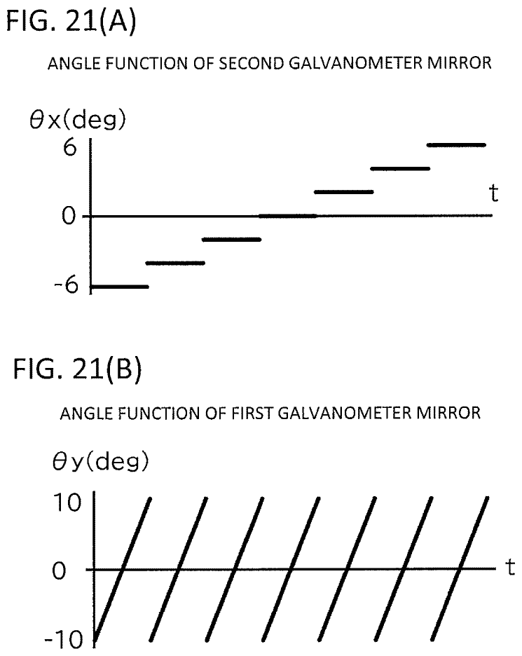

FIGS. 20(A) and 20(B) and FIGS. 21(A) and 21(B) are diagrams for explaining the distortion on a screen in the image sensing device 2 according to the second embodiment. FIG. 20(A) shows the locus of the laser beam on the illumination reference surface 14, and FIG. 20(B) shows the locus of the laser beam on the image capturing reference surface 24. FIG. 21(A) shows an angle function θx(t) of the galvanometer mirror 512, and FIG. 21(B) shows an angle function θy(t) of the galvanometer mirror 511.

When the galvanometer mirror 511 is scanned to and fro at a constant high speed and the galvanometer mirror 512 repeats the operation of scanning from the direction of +6 degrees to the direction of −6 degrees at a constant speed, the laser beam 90 on the illumination reference surface 14 in FIG. 19 draws a locus indicated by an upward-convex curved line arrow in FIG. 20(A). The laser beam 90 on the illumination reference surface 14 moves in a direction heading from −X toward +X as indicated by a solid line arrow in a forward path, and moves in the opposite direction as indicated by a dotted line arrow in a return path. Since the galvanometer mirror 512 is scanned slowly as compared to the galvanometer mirror 511, the linear illumination region 13 as the locus of the laser beam moves in a direction heading from +Y toward −Y on the entire screen. If the locus of the laser beam in this one-way movement is photographed for a time longer than or equal to the time necessary for the one-way movement (i.e., if the exposure time of the camera 20 is set sufficiently long), the illumination reference surface 14 can be considered to be irradiated with a laser beam in the curved line shape. Incidentally, the dots in FIG. 20(A) indicate arrival points of the laser beam on the illumination reference surface 14 when the rotation angles θx and θy of the galvanometer mirrors 511 and 512 are changed discretely by 1-degree steps.

A locus of the laser beam on the image capturing reference surface 24 arranged to be orthogonal to the optical axis 21 but oblique to the optical axis 11 has a shape like a solid line arrow or a dotted line arrow in FIG. 20(B). Similarly to the dots in FIG. 20(A), the dots in FIG. 20(B) indicate arrival points of the laser beam on the image capturing reference surface 24 when the rotation angles θx and θy of the galvanometer mirrors 511 and 512 are changed discretely by 1-degree steps. On the image capturing reference surface 24, the linear illumination region 13, which is the locus of the high-speed scan substantially in the horizontal direction, is not only being convex in the Y direction but also subject to rotation of its overall inclination in the period from the time t=ta to the time t=tc as indicated by the linear illumination regions 13a to 13c in FIG. 20(B). Since such a distorted linear illumination region 13 cannot be overlapped with the linear image capturing region 23 of the camera 20, the epipolar imaging cannot be performed.

Here, simple illustrations of the angle functions of the galvanometer mirror 511 and the galvanometer mirror 512, forming such a linear illumination region 13, in a time of one frame are shown in FIG. 21(A) and FIG. 21(B). FIGS. 21(A) and 21(B) show cases where the rotation angle θx of the galvanometer mirror 512 is displayed by step angles of 2 degrees and the rotation angle θy of the galvanometer mirror 511 changes only in a positive direction from −10 degrees to +10 degrees. The galvanometer mirror 512 in FIG. 21(A) performs an operation of maintaining a constant angle during a time of one scan by the galvanometer mirror 511 (defined as a time Tx). However, in the real operation in which the step regarding θx is finer, it is also possible that the galvanometer mirror 512 performs an operation of slowly changing the angle at a constant angular speed during the movement from −6 degrees to +6 degrees. This is because the angle θx can be regarded as being constant in the short time Tx. In FIG. 21(B), the galvanometer mirror 511 performs an operation of changing the angle θy at a constant speed during the time Tx.

The distortion is corrected by making corrections to the angle functions of the galvanometer mirrors shown in FIG. 21(A) and FIG. 21(B). Specifically, correction functions for correcting the patterns of the laser beam arrival positions at the 1-degree angular intervals indicated by the dots in FIGS. 20(A) and 20(B) to square lattice patterns are generated.

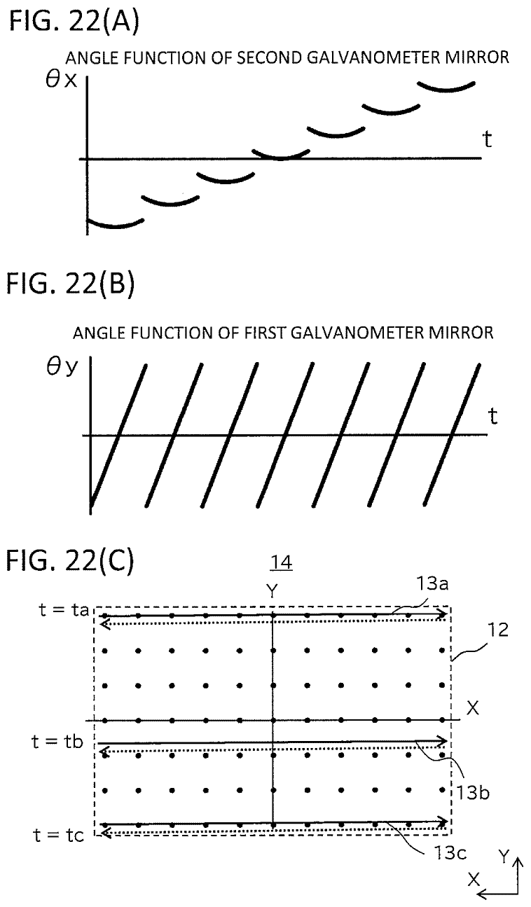

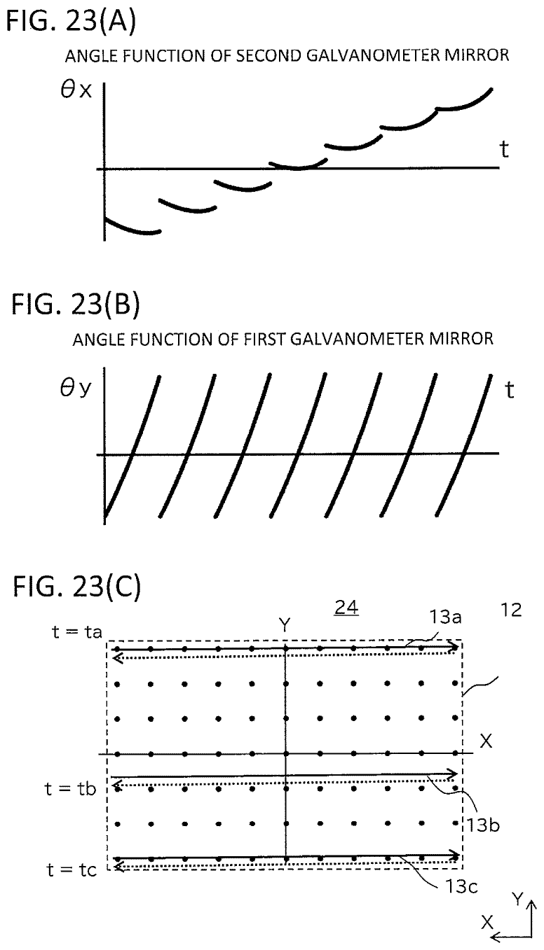

FIGS. 22(A) to 22(C) and FIGS. 23(A) to 23(C) are diagrams for explaining the distortion on the screen in the image sensing device 2 according to the second embodiment. FIGS. 22(A) and 22(B) show the angle functions of the galvanometer mirrors for correcting the distortion on the illumination reference surface 14, and FIG. 22(C) shows the locus of the laser beam on the illumination reference surface 14. FIGS. 23(A) and 23(B) show the angle functions of the galvanometer mirrors for correcting the distortion on the image capturing reference surface 24, and FIG. 23(C) shows the locus of the laser beam on the image capturing reference surface 24.

First, angle functions θy(t) and θx(t) that eliminate the distortion on the illumination reference surface 14 are generated. To obtain these functions, it is desirable to obtain a set of the angles θy and θx of the two galvanometer mirrors at which the laser beam arrives at each lattice point on the illumination reference surface 14 shown in FIG. 22(C). The position coordinates (X, Y) on the illumination reference surface 14 are in a one-to-one mapping relationship with the two angles θy and θx. Thus, in regard to a certain coordinate position (X, Y), the angles θy and θx at which the laser beam arrives at the coordinate position (X, Y) is numerically obtained. For example, functions regarding θy and θx like those shown in FIGS. 22(A) and 22(B) are obtained. In this example, to simplify the illustration in the drawings, the function regarding θy is assumed to be a function in which the galvanometer mirror 511 moves from −10 degrees to +10 degrees at a constant angular speed and thereafter instantaneously returns to −10 degrees and the function regarding θx is assumed to be a function in which θx changes from approximately −6 degrees to approximately +6 degrees stepwise by approximately 2 degrees. Each step of the function regarding θx is a curved line being convex downward. In this case, a locus being a line segment parallel to the X-axis is drawn like the rightward arrow of the linear illumination region 13a in FIG. 22(C). In the real operation, also when the galvanometer mirror 511 returns from +10 degrees to −10 degrees, the laser beam is scanned by similarly controlling the galvanometer mirror 512. It is also possible to change the angle θx by even finer steps. The locus of the laser beam in the return path is indicated by a leftward dotted line arrow in FIG. 22(C). Although the laser beam arrival positions on the illumination reference surface 14 when the set of θy and θx is swung by the 1-degree steps are distorted as shown in FIG. 20(A) as already described above, the linear illumination region 13a as the locus in FIG. 22(C) is corrected to a straight line by using the functions in FIGS. 22(A) and 22(B). Similarly, it is possible to generate a sequence of the sets of θy and θx that raster-scans the dots arrayed like a square lattice in FIG. 22(C) from the top left toward the right.

However, on the image capturing reference surface 24 inclined with respect to the optical axis 11, the locus is not parallel to the X-axis as indicated by the linear illumination regions 13a and 13c in FIG. 15(B) and the epipolar imaging cannot be implemented appropriately by this method only. However, in this case, since the linear illumination region 13 being horizontal and straight has been generated by the functions in FIGS. 22(A) and 22(B), the linear illumination region 13 being horizontal and straight can be generated on the image capturing reference surface 24 and the epipolar imaging is made possible by setting the trapezoidal distortion generation element 40 in front of the laser scanner 50 as described in the first embodiment.

However, if the two galvanometer mirrors 511 and 512 are controlled appropriately, the linear illumination region 13 in the shape of a straight line extending in the horizontal direction can be generated on the image capturing reference surface 24 without using the trapezoidal distortion generation element 40. In order to obtain the linear illumination region 13a by the horizontal laser beam scan on the image capturing reference surface 24 as shown in FIG. 23(C), it is sufficient to set the angle functions shown in FIGS. 23(A) and 23(B). FIG. 23(A) is a graph in which different rotations have been given respectively to the seven downward-convex curved lines shown in FIG. 22(A). As above, in order to correct the trapezoidal distortion occurring on the image capturing reference surface 24 inclined with respect to the optical axis 11, it is necessary to generate trapezoidal distortion in the opposite direction on the illumination reference surface 14 orthogonal to the optical axis 11, and for this purpose, it is necessary to control θx in the time of drawing one linear illumination region 13 and to slightly change its control function line by line. Further, in the dot pattern by the 1-degree steps in FIG. 20(B), the dot interval in the X direction gradually narrows with the increase in the value of X. For correcting the X direction interval, the set of seven straight line segments having a gradient of ascending to the right in FIG. 22(B) is changed to a set of curved lines slightly convex downward in FIG. 23(B). The linear illumination region 13 being horizontal in the X direction and straight shown in FIG. 23(C) is generated from the functions in FIGS. 23(A) and 23(B). Namely, the epipolar imaging is made possible if the two galvanometer mirrors 511 and 512 are operated by use of functions like those in FIGS. 23(A) and 23(B).

### (2-3) Effect

In the second embodiment, when the epipolar imaging is performed by raster-scanning the laser beam by using two galvanometer mirrors 511 and 512, it is possible to perform sensing that has been impossible by means of the epipolar imaging scanning the line laser beam in the vertical direction.

Further, it is possible to form a vertical stripe pattern by repeating the turning on and off of the laser lighting at high speed. For example, the lighting on-off control is performed 100 times while the laser beam moves once from left to right or from right to left in FIG. 23(C), and synchronization control is performed so that the lighting is turned on/off at the same position in the X direction in every line. Then, there appear 100 vertical stripes extending in the vertical direction. By performing three-dimensional (3D) measurement by using these vertical stripes, error-free sensing can be performed even on a metallic object. If the 3D measurement is performed on a metallic object by means of the stripe pattern projection method not being the epipolar imaging, false detection may be caused by a pseudo pattern formed by the stripe pattern reflected by a metallic luster surface. However, in the epipolar imaging, the reflected pseudo stripe pattern is not taken in by the camera 20 and thus 3D measurement free of false detection becomes possible.

### (3) Third Embodiment

### (3-1) Configuration

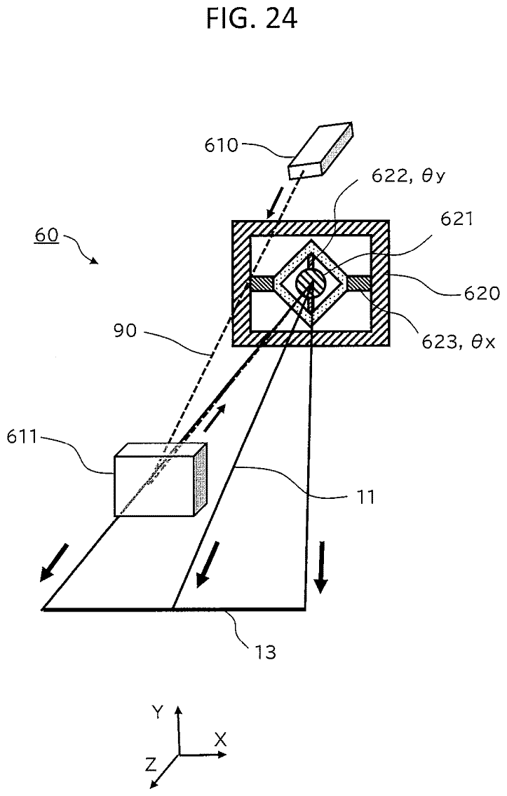

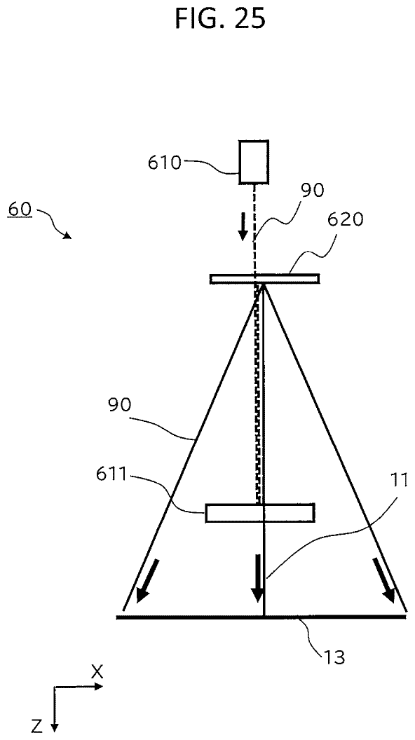

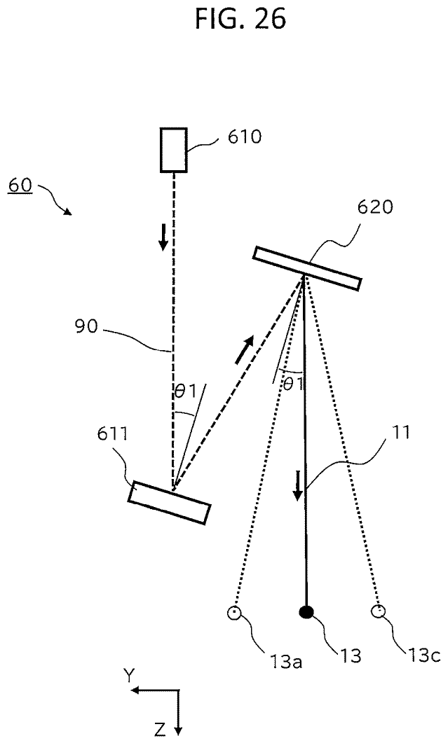

FIGS. 24 to 26 are a perspective view, a plan view and a side view schematically showing the configuration of a laser scanner 60 as the illumination device of an image sensing device 3 according to a third embodiment. The laser scanner 60. employing a two-dimensional MEMS mirror 620 is shown in FIGS. 24 to 26. Since the two-dimensional MEMS mirror 620 is capable of performing the raster scan by deflecting the laser beam in the biaxial directions similarly to the configuration employing the two galvanometer mirrors, the two-dimensional MEMS mirror 620 can be used as the device for generating the linear illumination region 13 for the purpose of performing the epipolar imaging. The laser scanner 60 employing the two-dimensional MEMS mirror 620 has advantages in being downsizable as compared to the galvanometer mirrors and being inexpensive. In FIGS. 24 to 26, the laser beam 90 emitted from a laser light source 610 travels in the Z-axis direction and is reflected by a mirror 611 whose normal line is inclined with respect to the −Z-axis by an angle θ1. The reflected light is further reflected by a mirror part 621 of the two-dimensional MEMS mirror 620.

As shown in FIG. 24, the two-dimensional MEMS mirror 620 is constituted by the mirror part 621 that reflects the laser beam 90, a hinge 622 that rotates the mirror part 621 by an angle θy around the Y-axis in the drawings, and a hinge 623 that rotates the mirror part 621 by an angle θx around the X-axis. The optical axis 11 of the laser scanner 60 is defined in the direction of the laser beam 90 when θy=θx=0, and the two-dimensional MEMS mirror 620 is installed with its normal line inclined to form the angle θ1 with the Z-axis so that the optical axis 11 is parallel to the +Z-axis.

The two-dimensional MEMS mirror 620 for performing the raster scan is generally constituted by a high-speed shaft capable of high-speed scanning but cannot be angular controlled with high accuracy and a low-speed shaft capable of low-speed scanning but can be angular controlled with high accuracy. High-accuracy control in the movement around the high-speed shaft is difficult because the scan is performed at high speed by setting the scan frequency to a physical resonance frequency. The scan angle θy around the high-speed shaft cannot be controlled by an arbitrary function and a reciprocating motion is repeated at a constant speed. In FIGS. 24 to 26, a rotational operation by use of the hinge 622 corresponds to a rotational scan around the high-speed shaft, and a rotational operation by use of the hinge 623 corresponds to a rotational scan around the low-speed shaft. By the motion around θy, the laser beam is scanned at high speed in the X direction and the linear illumination region 13 is formed. However, on the YZ plane, the laser beam 90 is obliquely incident upon the mirror part 621, and accordingly, the linear illumination region 13 obtained by the rotation of the mirror part 621 around the high-speed shaft draws an arc in the Y-axis direction.

### (3-2) Configuration Example 1

### <Case of Inhibiting Distortion on Oblique Screen by Free-Form Surface Lens>

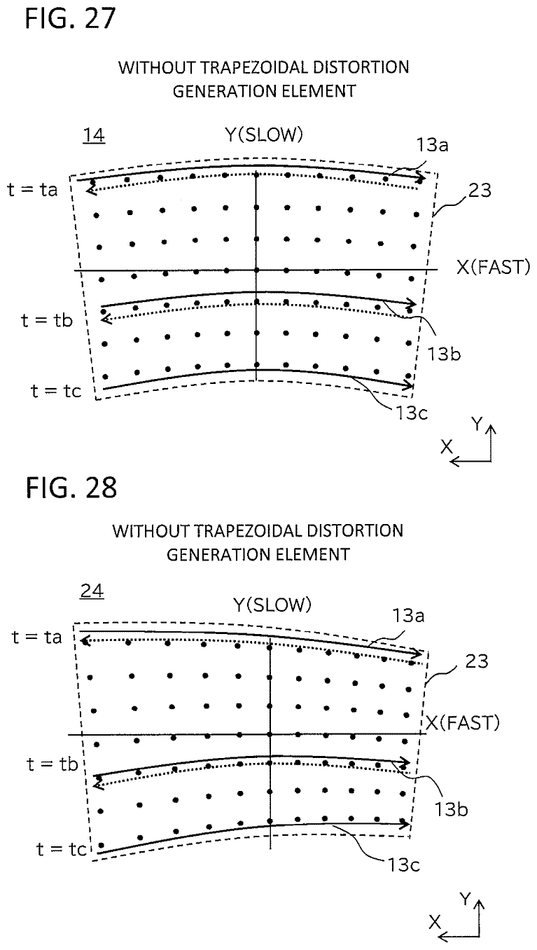

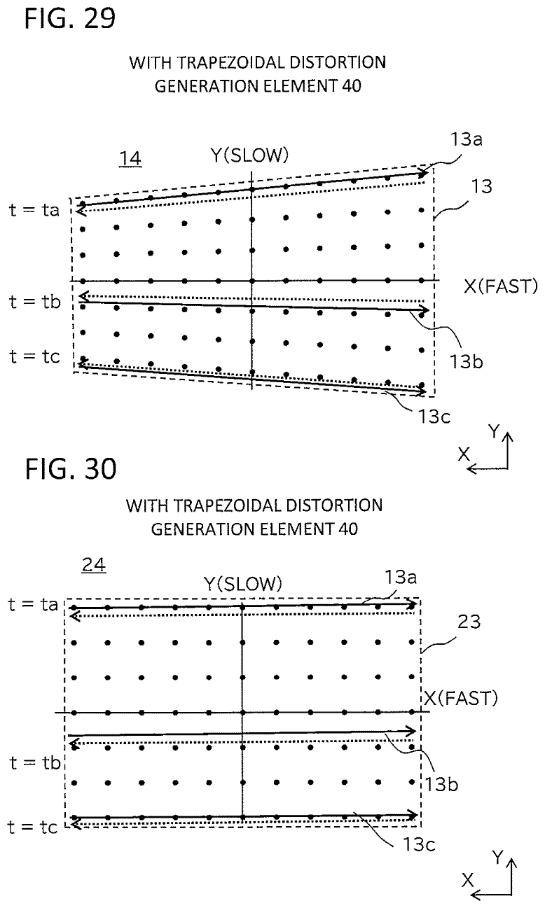

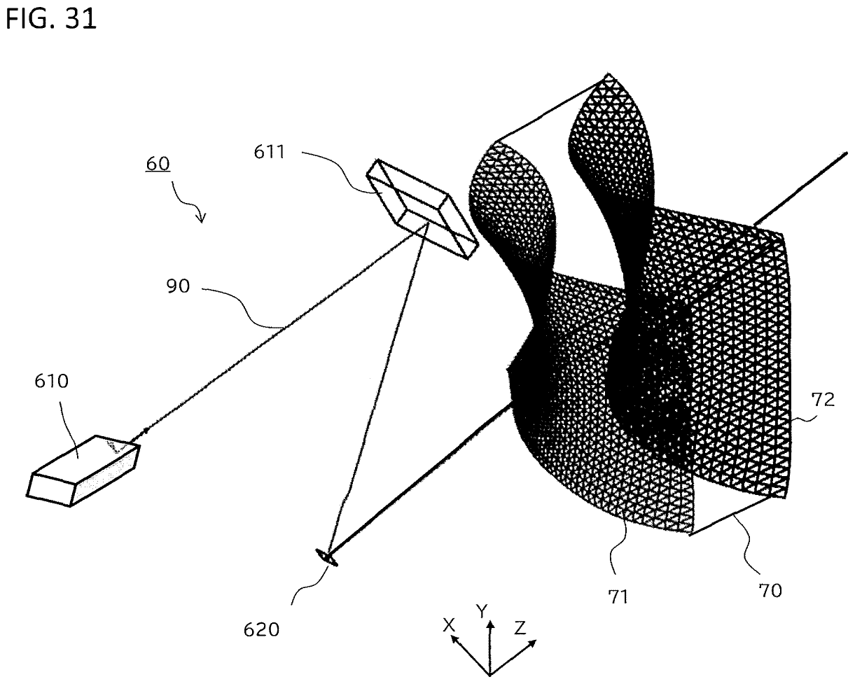

FIG. 27 is a diagram for explaining the distortion on the illumination reference surface 14 in an image sensing device in a comparative example (in a case where the device does not include a trapezoidal distortion generation lens). FIG. 28 is a diagram for explaining the distortion on the image capturing reference surface 24 in the image sensing device in the comparative example (in the case where the device does not include the trapezoidal distortion generation lens). In contrast, FIG. 29 is a diagram showing the locus of the beam on the illumination reference surface in the image sensing device 3 according to the third embodiment (overall configuration is not shown). FIG. 30 is a diagram showing the locus of the beam on the image capturing reference surface in the image sensing device 3 according to the third embodiment. The laser scanner 60 of the image sensing device according to the third embodiment is shown in FIGS. 24 to 26.

FIG. 27 shows the linear illumination region 13 as the locus drawn by the laser beam 90 on the illumination reference surface 14 orthogonal to the optical axis 11 when there is no trapezoidal distortion generation element 40. While the laser beam 90 draws a locus similar to the locus on the illumination reference surface 14 in FIG. 20(A) in the case of using two galvanometer mirrors, the locus in FIG. 27 varies in the curvature of the arc depending on the position in the Y direction and the curvature radius decreases as the locus advances downward. Namely, the curvature of arc of the linear illumination region 13c is greater than that of the linear illumination region 13a. Further, a swing width in the X direction also decreases as the locus advances downward. The reason for this is that the hinge 622 is situated on the inside of the hinge 623 in the two-dimensional MEMS mirror 620 and accordingly the incidence angle of the incidence upon the mirror part 621 on the YZ plane changes to (θ1+θx) according to the rotation angle θx by the hinge 623. Incidentally, similarly to the dots in FIG. 20(A), the dots in FIG. 27 to FIG. 30 indicate the arrival points of the laser beam 90 on the illumination reference surface 14 when θx and θy are changed by the 1-degree steps. For example, the dots in the vicinity of the linear illumination region 13a as the upper end of the linear illumination region 13 are the arrival points of the laser beam when θy is swung from −5 degrees to +5 degrees while fixing θx at −3 degrees.

FIG. 28 shows the arrival points of the laser beam and the linear illumination region 13 on the image capturing reference surface 24 set to be orthogonal to the optical axis 21 but oblique to the optical axis 11 when there is no trapezoidal distortion generation element 40 similarly to the case of FIG. 20(B). In FIG. 28, in addition to the arc-shaped distortion shown in FIG. 27, trapezoidal distortion due to the obliqueness of the image capturing reference surface 24 is superimposed. Incidentally, this trapezoidal distortion appears as the narrowing of the dot interval in the Y direction with the advancement in the −X direction.

In the case of the two-dimensional MEMS mirror, not only the trapezoidal distortion but also complicated distortion caused by the two-dimensional MEMS mirror itself is added, and thus it is difficult to appropriately correct the distortion on the oblique image capturing reference surface 24 by using an element in a simple shape like the wedge-shaped prism as an example of the trapezoidal distortion generation element 40 in the first embodiment. Therefore, it is desirable to use a free-form surface lens as the trapezoidal distortion generation element. As an example of a function shape representing a free-form surface, there is the following expression (1):

$$Z ( x , y ) = {\sum }_{m = 1}^{N} {\sum }_{j = 0}^{m} \frac{1}{{a}^{m}} {k}_{m - j , j} {x}^{m - j} {y}^{j} \qquad ( 1 )$$

Here, Z(x, y) is a displacement amount of a curved surface at the coordinates (x, y) and represents an N-degree polynomial of two variables x and y. Variables are made up of “a” as a normalization parameter and k_{i,j} as a coefficient for xⁱy^{j}. Here, the optimization of the free-form surface shape was carried out assuming that N=6-th degree. FIG. 29 and FIG. 30 respectively show the arrival positions of the laser beam by the 1-degree steps and the linear illumination region 13 on the illumination reference surface 14 and the image capturing reference surface 24 after the optimization.

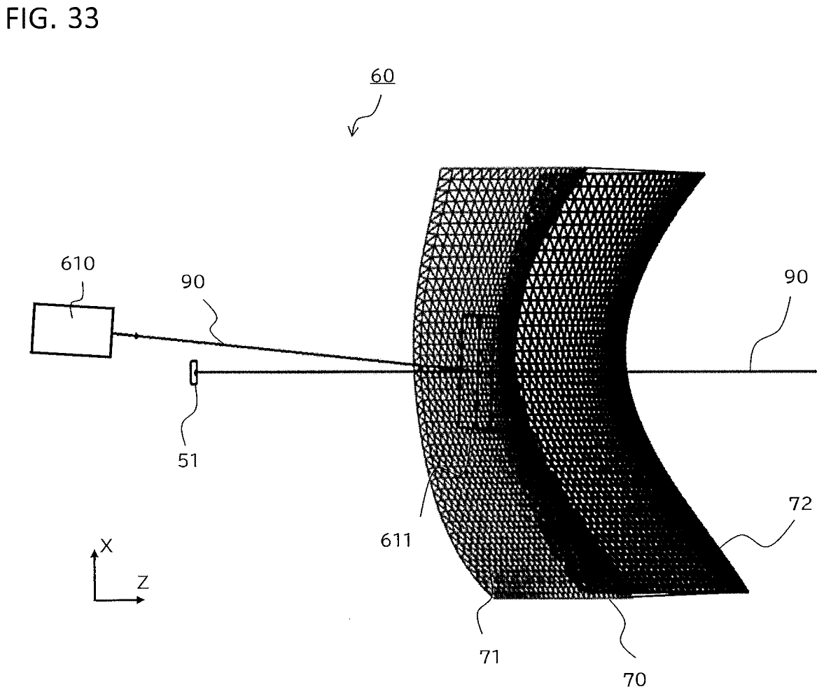

FIG. 31 to FIG. 33 are a perspective view, a side view and a plan view schematically showing the configuration of the laser scanner 60 including the free-form surface lens in the image sensing device 3 according to the third embodiment. FIG. 31 to FIG. 33 are diagrams showing a free-form surface lens 70 inserted after the two-dimensional MEMS mirror 620 in FIG. 24 to FIG. 26. Each of a first surface 71 and a second surface 72 of the free-form surface lens 70 is a free-form surface represented by the expression (1).

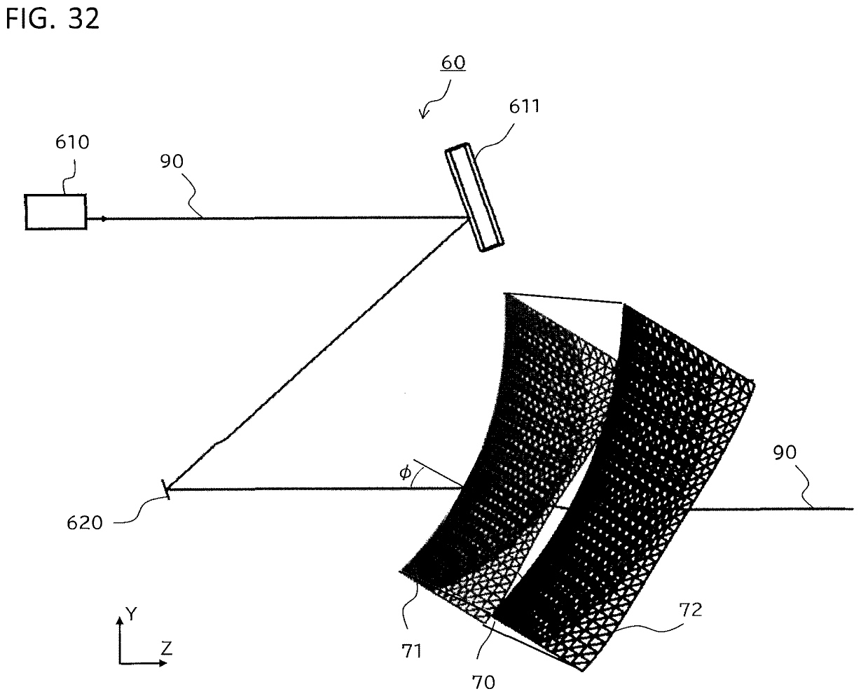

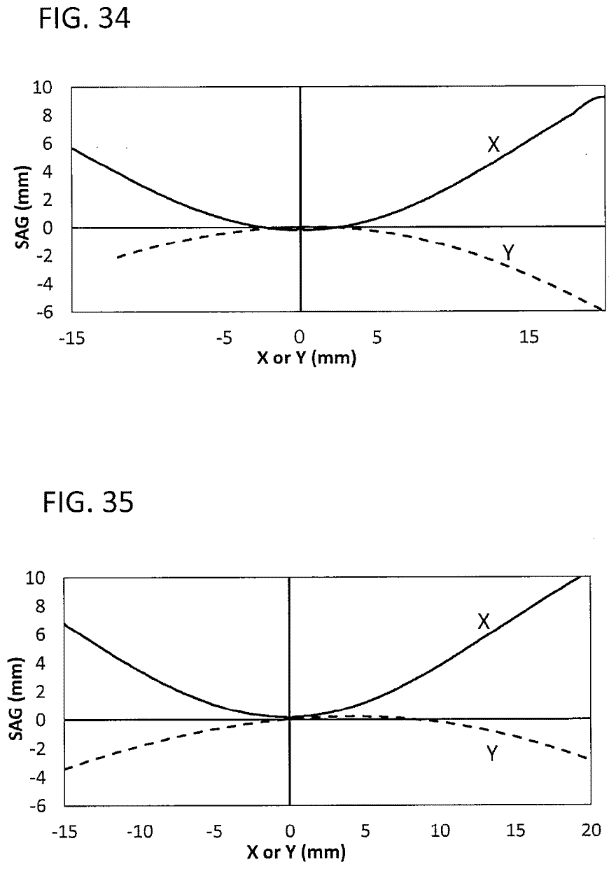

FIG. 34 and FIG. 35 are diagrams showing cross-sectional profiles of the first surface 71 and the second surface 72 of the free-form surface lens 70 of the image sensing device 3 according to the third embodiment. FIG. 34 and FIG. 35 respectively show the cross-sectional profiles of the first surface 71 and the second surface 72 on a surface passing through the optical axis. The solid line indicates a SAG amount [mm] in the X direction and the broken line indicates the SAG amount in the Y direction. The SAG amount is a scraping amount in a direction parallel to the optical axis of the lens. Each of FIG. 34 and FIG. 35 indicates that the curvatures in the X direction and the Y direction are of opposite polarities and the curved surface is in a saddleback shape. Further, each of FIG. 34 and FIG. 35 indicates that the graph is bilaterally asymmetrical both in the X direction and the Y direction and it is necessary to use a free-form surface lens being asymmetrical both in the X direction and the Y direction in order to correct the asymmetrical distortion like that in FIG. 35 to the state in FIG. 30. Furthermore, as shown in FIG. 32, the free-form surface lens 70 is attached in a state of being rotated clockwise in a YZ plane by an angle φ. An incident ray and an emerging ray (i.e., optical axes 11) of the laser beam 90 incident on and emerging from the free-form surface lens 70 when θy=θx=0 are both in the Z-axis direction. An angle formed by this incident ray and a normal line to the first surface 71 on the optical axis is φ=30 degrees. It was confirmed in a simulation conducted by the inventors of the present application that it was possible to design the free-form surface shape so as to cancel the difference in the curvature of the linear illumination region 13 on the screens (i.e., the illumination reference surface 14 and the image capturing reference surface 24) shown in FIG. 27 and FIG. 28 when φ was in a range from 15 degrees to 45 degrees.

As described above, by inserting the appropriately designed free-form surface lens 70 being asymmetrical both in the X and Y directions after the two-dimensional MEMS 620, the linear illumination region 13 parallel to the X direction can be generated even on the image capturing reference surface 24 orthogonal to the optical axis 21 of the camera 20 as shown in FIG. 30 and the epipolar imaging can be performed.

### (3-3) Configuration Example 2

### <Case of Inhibiting Distortion by Angular Control of Low-Speed Shaft>

While the linear illumination region 13 in the straight line shape is generated on the image capturing reference surface 24 set obliquely to the optical axis 11 by using the free-form surface lens 70 in the configuration example 1, it is also possible to inhibit the distortion by controlling the rotation angles θx and θy of the mirror part 621 similarly to the case of the two galvanometer mirrors described in the second embodiment. The control method and the angle functions in this case are the same as those described above by using FIG. 22 and FIG. 23. If the scan angle θx around the low-speed shaft (i.e., around the hinge 623) and the scan angle θy around the high-speed shaft (i.e., around the hinge 622) can be controlled by functions like those shown in FIGS. 23(A) and 23(B), that is, if the values of θx and θy can be controlled appropriately in the short time of drawing the locus of one linear illumination region 13, the linear illumination region 13 formed by the line beam can be transformed to a straight line parallel to the X direction and the epipolar imaging becomes possible.

However, the rotation around the high-speed shaft (i.e., around the hinge 622) in the two-dimensional MEMS mirror uses the resonance phenomenon as described above, and thus it is difficult to perform the control by setting arbitrary angle functions. Even in such cases, if the scan angle θx around the low-speed shaft (i.e., around the hinge 623) can be controlled, the linear illumination region 13 as the locus of the laser beam on the image capturing reference surface 24 can be made parallel to the X direction.

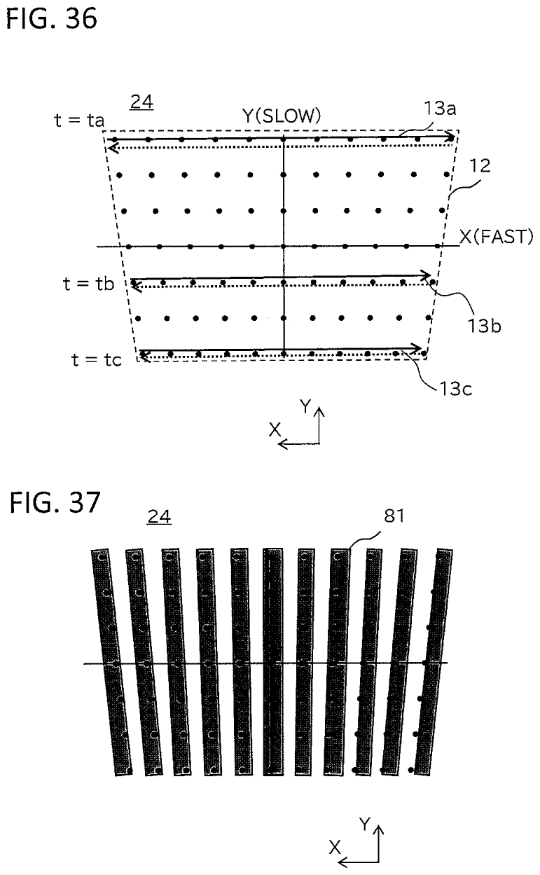

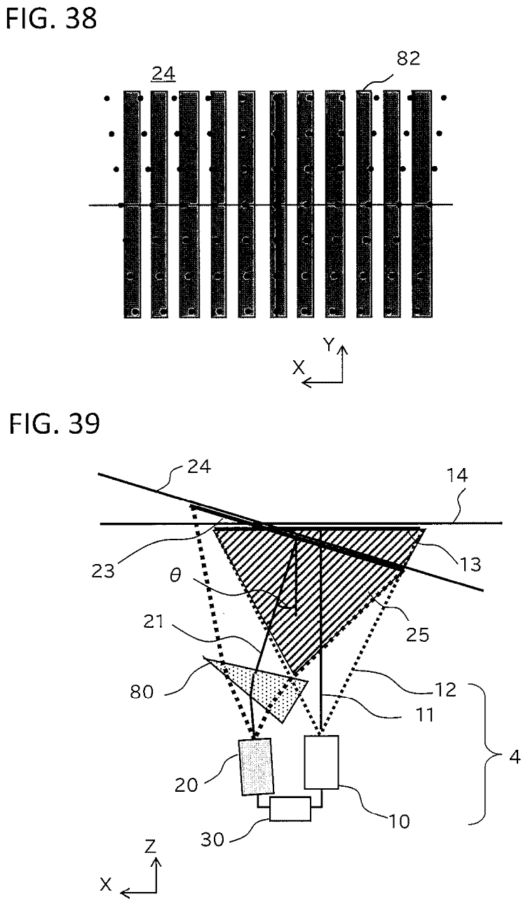

FIG. 36 is a diagram showing the locus of the laser beam on the image capturing reference surface 24 obtained by controlling the low-speed shaft of the two-dimensional MEMS mirror of the image sensing device 3 according to the third embodiment. FIG. 37 shows a stripe pattern 81 formed when the laser beam is turned on and off at even time intervals, and FIG. 38 shows an example of a vertical stripe pattern 82 being vertical formed by controlling on and off times of the laser beam. In this case, the linear illumination region 13 and the laser beam arrival points by the 1-degree steps on the image capturing reference surface 24 are formed as shown in FIG. 36, FIG. 37 and FIG. 38. In the drawings, every linear illumination region 13 is parallel to the X direction even though the length of the linear illumination region 13 decreases with the advancement from the top to the bottom. Even in such cases, it is possible to perform the epipolar imaging.

For example, use of the stripe pattern projection method as the three-dimensional sensing will be considered below. The stripe pattern projection method is a method of projecting a vertical stripe pattern onto a 3D object, photographing the stripe pattern on the 3D object from an oblique angle, and reconstructing the 3D shape based on the manner of distortion of the stripe pattern, and is a method known as a type of an active stereographic method. If the laser is turned on and off at even intervals when the device has a trapezoidal illumination region like that shown in FIG. 36, a stripe pattern 81 in the vertical direction like that shown in FIG. 37 is obtained. This stripe pattern 81 has a pattern in which the angle from the Y-axis increases with the increase in the distance in the X direction. While the stripe pattern projection method is possible even with such a pattern, an error is likely to occur since the stripe pattern projected is not formed of parallel lines at even intervals.

In order to form a stripe pattern in which all the lines are vertical, it is effective to control the laser on-off time interval. If the on-off time interval is controlled to increase as the linear illumination region 13 advances from the top to the bottom, a vertical stripe pattern 82 like that shown in FIG. 38 is obtained. By using such a vertical stripe pattern 82, the error can be reduced in the three-dimensional sensing by means of the stripe pattern projection method. Further, since the epipolar imaging is performed, three-dimensional sensing with a reduced error and with little influence of the reflected stray light is possible when photographing a metallic luster surface or the like.

### (3-4) Configuration Example 3

### <Case of Inhibiting Distortion by Free-Form Surface Lens and Mirror Angle Control>

While the case where the distortion is inhibited on the image capturing reference surface 24 set obliquely to the optical axis 11 by using the free-form surface lens and the case where the distortion is inhibited by controlling the scan angle θx around the low-speed shaft (i.e., around the hinge 623) have been described above, it is also possible to consider a case (hybrid method) where both methods are used. For example, the free-form surface lens has a complicated shape with large SAG amounts as described above by using FIG. 31 to FIG. 35 and an error in the surface shape is likely to occur. Further, an alignment error is also likely to occur since the free-form surface lens is set obliquely to the optical axis. Upon the occurrence of such an assembly error, the linear illumination region 13 on the image capturing reference surface 24 might be slightly distorted from the straight line shape. Such slight distortion from the straight line shape can be corrected by the angular control of the mirror. In the angular control of the mirror part in this case, the amount of correction of the scan angle θx around the low-speed shaft (i.e., around the hinge 623) is allowed to be small as compared to the case where the distortion is inhibited by the mirror angle control alone. For the correction of the assembly error, it is desirable to measure the irradiation pattern on the screen after the assembling of the laser scanner 60 and perform the mirror angle control so as to correct a deviation from a design value.

Further, in the case of attempting to inhibit the distortion by the mirror angle control alone, even the control only by the scan angle θx around the low-speed shaft (i.e., around the hinge 623) requires considerably high acceleration/deceleration. Thus, due to the performance of the two-dimensional MEMS, there are cases where sufficient angular control cannot be performed and the distortion cannot be inhibited. However, in the hybrid method, the angle of the mirror part 621 can be controlled with weaker force and the control accuracy increases, and thus the linear illumination region 13 having the parallelism sufficient for the epipolar imaging can be obtained.

### (4) Fourth Embodiment

FIG. 39 is a plan view schematically showing a main configuration of an image sensing device 4 according to a fourth embodiment. While the trapezoidal distortion generation element 40 is arranged in front (i.e., on a projection side) of the laser scanner 10 in the first embodiment, a trapezoidal distortion generation element 80 is arranged in front (i.e., on an image capturing side) of the camera 20 in the fourth embodiment. The trapezoidal distortion generation element 80 has a function of making the extending direction of the linear image capturing region 23 approach the extending direction of the linear illumination region 13 on the illumination reference surface 14.

In FIG. 39, the optical axis 21 of the camera 20 is inclined with respect to the Z direction by an angle θ. While the trapezoidal distortion occurs on the image capturing reference surface 24 orthogonal to the optical axis 21 due to the insertion of the trapezoidal distortion generation element 80, the distortion is corrected on the illumination reference surface 14 orthogonal to the laser scanner 10. Namely, in the fourth embodiment, the reference surface that aligns the linear illumination region 13 in the X direction is the illumination reference surface 14. In such cases, when the linear image capturing region 23 of the camera 20 and the linear illumination region 13 are scanned in synchronization with each other, it is possible to scan the linear image capturing region 23 and the linear illumination region 13 on the illumination reference surface 14 in the state of keeping on overlapping with each other (preferably, in the state of constantly overlapping with each other) (namely, it is possible to perform the epipolar imaging) similarly to the movement on the image capturing reference surface 24 in FIG. 6(E).

By making the optical axis 21 intersect with the optical axis 11 by the insertion of the trapezoidal distortion generation element 80, an advantage is obtained in that the sensing region 25 in FIG. 39 is made wider than the sensing region of the image sensing device in the comparative example shown in FIG. 11 and FIG. 12.

Incidentally, except for the above-described features, the fourth embodiment is the same as the first embodiment.

### DESCRIPTION OF REFERENCE CHARACTERS

1-4: image sensing device, 10, 50, 60: laser scanner (illumination device), 11: optical axis, 12: entire laser scan range, 13: linear illumination region, 14: illumination reference surface (illumination screen), 20: camera, 21: optical axis, 22: entire image capturing range, 23: linear image capturing region, 24: image capturing reference surface (image capturing screen), 25: sensing region, 30: control circuit, 40: trapezoidal distortion generation element, 70: free-form surface lens, 80: trapezoidal distortion generation element, 90: laser beam (optical beam), 110, 510, 610: laser light source (light source), 111, 611: mirror, 113: galvanometer mirror (scanning optical unit), 211: galvanometer mirror (first scanning optical unit), 212: galvanometer mirror (second scanning optical unit), 620: two-dimensional MEMS mirror, X: horizontal direction (first direction), Y: vertical direction (second direction).

1. An image sensing device comprising:
an illumination device including a light source that emits an optical beam and an illumination optical system that scans a linear illumination region, which linearly extends in a first direction on a virtual reference surface as an illumination region onto which the optical beam is projected, in a second direction as a direction orthogonal to the first direction;
a camera that executes a photographing operation of scanning a linear image capturing region, which is an image capturing region linearly extending in the first direction on the reference surface, in the second direction; and
a control circuit that controls operation of the illumination device and the photographing operation of the camera so that the linear illumination region and the linear image capturing region keep on overlapping with each other on the reference surface,
wherein an optical axis of the illumination device and an optical axis of the camera are non-parallel to each other and intersect with each other in front of the illumination device and the camera.

2. The image sensing device according to claim 1, wherein the illumination optical system includes:
a beam expanding optical element that generates an expanding beam as a beam obtained by expanding the optical beam, which is emitted from the light source, in the first direction; and
a scanning optical unit that scans the linear illumination region, which is formed on the reference surface by the expanding beam, in the second direction.

3. The image sensing device according to claim 2, further comprising a trapezoidal distortion generation element arranged in front of the illumination device,
wherein the trapezoidal distortion generation element has a function of making an extending direction of the linear illumination region approach an extending direction of the linear image capturing region on the reference surface.

4. The image sensing device according to claim 3, wherein the trapezoidal distortion generation element is a free-form surface lens being asymmetrical in the first direction and asymmetrical in the second direction.

5. The image sensing device according to claim 2, further comprising a trapezoidal distortion generation element arranged in front of the camera,
wherein the trapezoidal distortion generation element has a function of making an extending direction of the linear image capturing region approach an extending direction of the linear illumination region on the reference surface.

6. The image sensing device according to claim 1, wherein the illumination optical system includes:
a first scanning optical unit that forms the linear illumination region by scanning the optical beam, which is emitted from the light source, in the first direction; and
a second scanning optical unit that scans the linear illumination region in the second direction.

7. The image sensing device according to claim 1, wherein the illumination optical system performs a first scan of forming the linear illumination region by scanning the optical beam, which is emitted from the light source, in the first direction and a second scan of scanning the linear illumination region in the second direction.

8. The image sensing device according to claim 7, wherein the illumination optical system is a two-dimensional MEMS mirror.

9. The image sensing device according to claim 8, wherein the scan in the first direction is performed by control of the two-dimensional MEMS mirror by rotation around a high-speed shaft, and
wherein the scan in the second direction is performed by control of the two-dimensional MEMS mirror by rotation around a low-speed shaft.

10. The image sensing device according to claim 8, wherein scan angle control of the scan in the first direction and scan angle control of the scan in the second direction are executed by using previously obtained angle functions.

11. The image sensing device according to claim 7, further comprising a free-form surface lens arranged in front of the illumination device.
